(19) United States
(12) Patent Application Publication
(10) Pub. No.: US 2025/0277517 A1
(43) Pub. Date: Sep. 4, 2025

(54) DISC BRAKE HAVING A PARTICLE EXTRACTOR, AND EXTRACTION SYSTEM FOR A DISC BRAKE

(71) Applicant: ZF CV Systems Europe BV, Brussels (BE)

(72) Inventors: Jannis Hecker, Plankstadt (DE); Paul Henning, Schwetzingen (DE)

(21) Appl. No.: 19/063,622

(22) Filed: Feb. 26, 2025

(30) Foreign Application Priority Data
Feb. 29, 2024 (DE) 10 2024 105 794.7

(51) Int. Cl. F16D 65/00; F16D 55/00

(52) U.S. Cl. CPC F16D 65/0031; F16D 65/0068; F16D 2055/0016

(57) ABSTRACT

A disc brake (1) for a motor vehicle has a brake disc and a brake caliper (4), in which two brake pads and a mechanism for actuating the brake pads are arranged, as well as a casing (12) that fits around the brake disc in some region or regions. The casing (12) has a suction connection (80) for a dust particle extractor. In one exemplary embodiment, an air-operated suction device (18) is secured on the suction connection of the casing (12). The suction device is connectable to a compressed air source of the vehicle. The compressed air may be used to generate a vacuum via the Coanda or Venturi effect, thereby causing an air mass to move away from the suction connection. A single suction device may be used for multiple disc brakes, with respective connecting lines extending to respective suction connections.

### FIELD

The present disclosure relates to a disc brake having a particle extractor for a motor vehicle and to an extraction system for at least one disc brake of a motor vehicle.

### BACKGROUND

Disc brakes in motor vehicles have brake pads, which are pressed by an actuator onto a brake disc connected to a wheel to be braked depending on actuation of a brake value transmitter, in order to enable a braking effect to be transmitted to the brake disc and thereby to the wheel. If the motor vehicle is braked, the braking process in the disc brake leads to particle abrasion in the form of brake dust, which is harmful to the environment.

EP 4 283 155 A1 discloses an air-ducting arrangement for a disc brake of a vehicle, wherein the air-ducting arrangement has a structural element that fits around a brake disc of the disc brake in some region or regions, as well as an air inlet, through which air is passed into the structural element. Arranged in the structural element is a filter, which absorbs the brake dust formed in the disc brake during a braking process.

### SUMMARY

It is an object of the present disclosure to provide a disc brake for a motor vehicle as well as an extraction system for at least one disc brake of a motor vehicle, by way of which pollution of the environment by brake dust formed during a braking process is reduced.

This object is achieved by a disc brake and by an extraction system as disclosed herein.

The present disclosure further contains advantageous further developments and improvements of the disc brake and extraction system in accordance with the description herein.

The present disclosure relates to a disc brake for a motor vehicle, which has a brake disc and a brake caliper, in which two brake pads and a mechanism for actuating the brake pads are arranged. The disc brake furthermore has a casing, which has a suction connection for a particle extractor, wherein the casing fits around the brake disc in some region or regions.

In one advantageous exemplary embodiment, the brake disc has a brake disc pot and a friction ring, which is firmly connected to the brake disc pot. In this case, the brake caliper and the casing completely surround the friction ring, with the exception of an air gap which remains between the casing and the friction ring.

In another advantageous exemplary embodiment, an air-operated suction device is secured on the suction connection of the casing.

In another advantageous exemplary embodiment, the suction device is a vacuum generator, the mode of operation of which is based on a Coanda effect.

In another advantageous exemplary embodiment, the suction device is a vacuum generator, the mode of operation of which is based on a Venturi effect.

In another advantageous exemplary embodiment, the casing has a dust container, in which a filter, in particular an air filter, is arranged.

In another advantageous exemplary embodiment, the suction connection for the particle extractor is arranged on the dust container.

The present disclosure furthermore relates to an extraction system for at least one disc brake of a motor vehicle, wherein the extraction system has a suction device which contains a compressed air connection for connection to a compressed air system of the motor vehicle, and contains a suction inlet and a connecting line for connection to the suction connection of the casing of the disc brake.

In one preferred embodiment, the extraction system has connecting lines to all of the disc brakes of the motor vehicle for particle extraction from the disc brakes, wherein all of the disc brakes have a casing with a suction connection, and each suction connection of the casings is connected to the air-operated suction device via a connecting line for this purpose.

In another preferred embodiment, the suction system has a particle extractor with just one air-operated suction device.

In another preferred embodiment, the suction system has one or more filters, in particular air filters, arranged centrally in the motor vehicle.

In another preferred embodiment, the motor vehicle is a commercial vehicle with a compressed air system, wherein the extraction system has connecting lines to all the disc brakes of the motor vehicle for particle extraction from the disc brakes.

### BRIEF DESCRIPTION OF THE DRAWINGS

Exemplary embodiments of the present disclosure are illustrated schematically in the drawings and are explained in greater detail below with reference to the figures. In the Figures:

FIG. 1 shows a disc brake for a motor vehicle, which has a casing that fits around a brake disc of the disc brake in some region or regions, and which has a dust container with an air filter, and a suction device secured on the casing;

FIG. 2 shows a suction device, the functioning of which is based on a Coanda effect;

FIG. 3 shows a suction device, the functioning of which is based on a Venturi effect; and

FIG. 4 shows a second exemplary embodiment of a disc brake for a motor vehicle, which has a dust container with an air filter, and a suction connection for particle extraction is secured on a casing of the disc brake.

### DETAILED DESCRIPTION

The present description clarifies the principles according to the present disclosure. It is therefore self-evident that those skilled in the art will be capable of conceiving of various arrangements which, although not explicitly described here, embody principles according to the present disclosure and are likewise intended to be protected within the scope thereof.

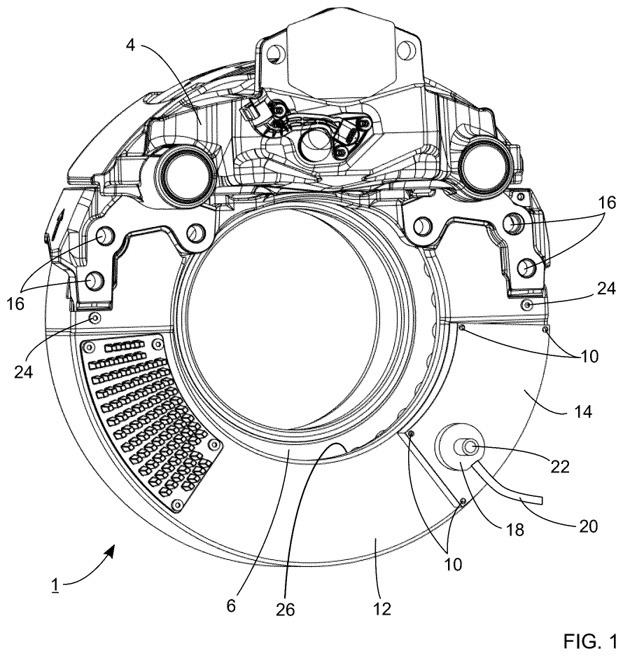

FIG. 1 schematically illustrates a disc brake 1 for a motor vehicle, which includes a brake disc and a brake caliper 4. Two brake pads and a mechanism for actuating the brake pads are arranged in the brake caliper 4. The brake disc has a brake disc pot 6 and a friction ring, which is firmly connected to the brake disc pot 6.

In this exemplary embodiment, the brake caliper 4 is positioned over the brake disc, and the lower part of the friction ring is surrounded by a casing 12, on which a dust container 14 with a filter, in particular an air filter, is secured. The air filter completely fills, in particular, the chamber of the dust container 14. The dust container 14 is preferably screwed to the casing 12, in this case by way of screws 10, thus enabling the air filter to be changed when required. The brake caliper 4 has holes 16, through which the disc brake 1 can be secured on an axle of the motor vehicle. In this exemplary embodiment, the casing 12 is screwed to the brake caliper 4 by way of screws 24.

A suction device 18 for air extraction is arranged on the dust container 14. The suction device 18 has a suction inlet, a compressed air connection 20 and an outlet 22. In this case, the dust container 14 has a suction connection, wherein the suction inlet of the suction device 18 is coupled to the suction connection of the dust container 14.

In this case, the friction ring of the brake disc is almost completely encapsulated by the brake caliper 4, the casing 12, and the dust container 14, thus enabling brake dust from the brake pads and the friction ring that is formed by a braking process in the disc brake 1 to be drawn in by way of the suction device 18 and deposited in the air filter. In this case, the air filter is permeable for the air drawn in but absorbs the brake dust and other particles. In the exemplary embodiment in FIG. 1, the air filter is arranged ahead of the suction device 18, thus ensuring dust-free operation of the suction device 18.

In this case, the casing 12 surrounds the friction ring almost completely, such that an air gap 26 remains between the casing 12 and the friction ring, ensuring that the casing 12 does not touch the friction ring. Friction between the casing 12 and the friction ring is thereby avoided. In addition, ambient air enters the casing 12 via the air gap 26, and, during the operation of the air extractor, this air then takes along the brake dust which arises during a braking process.

The disc brake 1 is, for example, an air-operated disc brake for a commercial vehicle, and the suction device 18 is, in particular, an air-operated suction device. Air-operated suction devices have no moving parts and can be produced very compactly, thus enabling a suction device of this kind to be secured directly on the dust container 14, for example.

Air-operated suction devices in the form of Venturi extractors or Coanda extractors, for example, are known. In commercial vehicles, there is usually already a compressed air system, in particular for the operation of disc brakes of the commercial vehicle, and therefore the air-operated suction device can be operated by the compressed air system via a connecting line connected to a compressed air connection of the suction device. For the operation of the suction device, it is also possible, for example, to incorporate a pressure regulator or some other device for compressed air regulation between the compressed air system and the suction device.

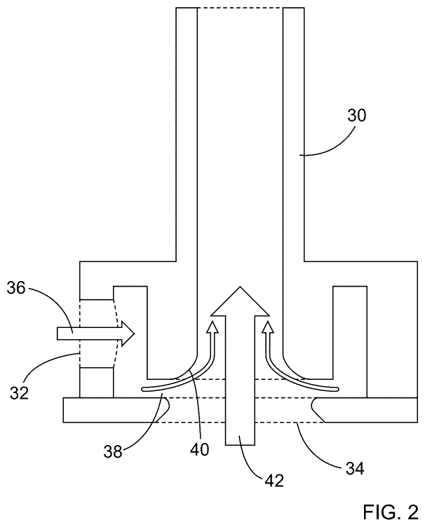

A suction device 30, the mode of operation of which is based on a Coanda effect, is illustrated schematically in a cross section in FIG. 2. The suction device 30 has a compressed air connection 32, which is coupled to the compressed air system of the commercial vehicle via a connecting line, and a suction inlet 34. The suction inlet 34 is connected to the suction connection of the casing 12 of FIG. 1 via a connecting line, for example. Alternatively, the suction device 30 is arranged directly on the suction connection of the casing 12, as illustrated in FIG. 1.

The Coanda effect describes adhesion of a flow to a curved surface. In the suction device 30, compressed air 36 is passed through an annular gap 38 and thus accelerated. As a result, the speed of flow of the compressed air 36 in the suction device 30 is increased, wherein the compressed air 36 emerging from the annular gap 38 follows a convex surface 40 of the suction device 30. This has the effect that the ambient air present in the suction device 30 is taken along. As a result, an air mass 42 is drawn in via the suction inlet 34, ensuring that the air present within the casing 12 of the disc brake 1 is extracted together with the brake dust produced during a braking process.

The secondary volume flow through the suction inlet 34 produced by the suction device 30, i.e. the air mass 42 drawn in, can be, for example, up to ten times greater than the primary volume flow through the compressed air connection 32, i.e. the compressed air 36 supplied, depending on the embodiment and use of the suction device 30.

Suction devices which use the Coanda effect are used in industry as flow grippers, for example. A flow gripper can achieve a vacuum of 25 to over 150 mbar, for example, if the flow gripper is operated at an operating pressure in a range of from 1 to 5 bar. In the range of from 1 to 5 bar, it is possible in this case to achieve a suction capacity of about 270 to 650 l/min with the flow gripper, with an air consumption of 60 to 200 l/min.

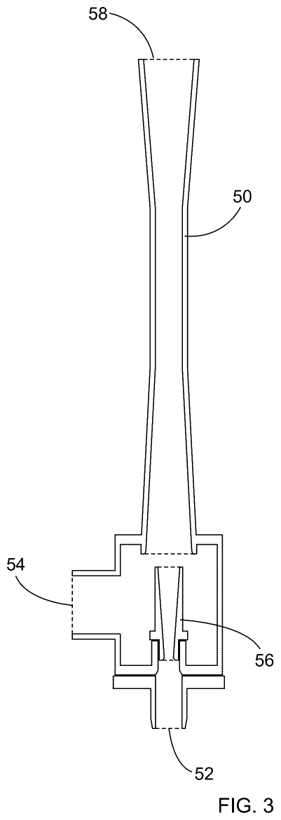

A suction device 50, the mode of operation of which is based on a Venturi effect, is illustrated schematically in a cross section in FIG. 3. The suction device 50 has a compressed air connection 52, which is coupled to the compressed air system of the commercial vehicle, for example, via a connecting line, and a suction inlet 54, which is connected to the suction connection of the casing 12 in FIG. 1 via a connecting line. Alternatively, the suction device 50 is arranged directly on the suction connection of the casing 12.

The Venturi effect works as follows: In the case of the suction device 50, compressed air entering at the compressed air connection 52 is accelerated in a jet nozzle 56 of the suction device 50, referred to as a Venturi nozzle. After passing through the jet nozzle 56, the accelerated air expands, and a vacuum forms. Owing to the vacuum formed, air is drawn in via the suction inlet 54 and then emerges from the suction device 50 together with the compressed air via an outlet 58.

Suction devices based on the Venturi effect can likewise be used as flow grippers, with it being possible to achieve larger vacuums with these suction devices than with suction devices based on the Coanda effect. In the case of a suction device based on the Venturi effect, however, a higher primary volume flow is required than is produced as a secondary flow. However, this can be compensated for by a multi-stage construction of the suction device.

Both Coanda suction devices and Venturi suction devices normally have no moving parts, making them shock-resistant. This makes them particularly suitable for use on an unsprung wheel end.

In another embodiment of the present disclosure, a commercial vehicle has a plurality of disc brakes and an extraction system with an air-operated particle extractor that has at least one air-operated suction device of the type described above. In this case, the particle extractor is preferably arranged centrally in the commercial vehicle. Commercial vehicles generally have a compressed air system for operating the disc brakes, and this can therefore be used to operate the suction device.

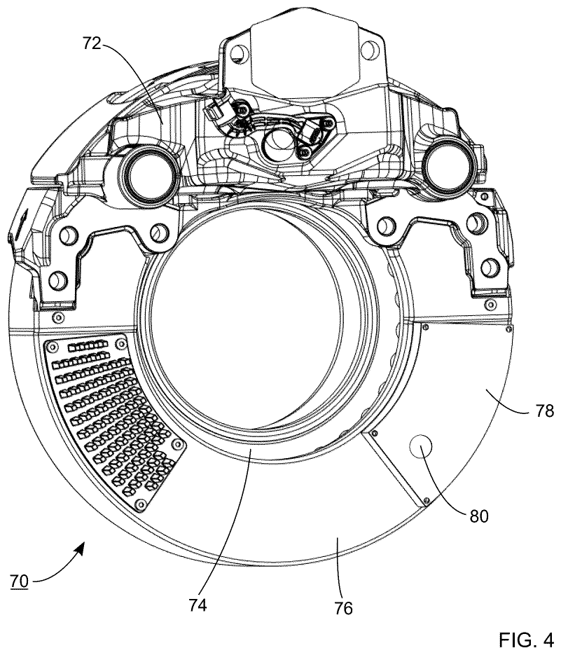

A disc brake 70 for this use is illustrated schematically in FIG. 4. The disc brake 70 comprises a brake caliper 72 and a brake disc with a friction ring and a brake disc pot 74 and, in this exemplary embodiment, corresponds substantially to the disc brake 1 of FIG. 1. The lower part of the friction ring is surrounded by a casing 76, on which a dust container 78 with a filter, in particular an air filter, is secured. Arranged on the dust container 78 in this exemplary embodiment is a suction connection 80, to which a connecting line for an air extractor can be connected.

In this case, preferably all of the disc brakes of the commercial vehicle each have a casing with a suction connection of this kind, wherein each suction connection of the casings is connected to the air-operated suction device via a connecting line. For example, the extraction system can have a particle extractor with just one air-operated suction device for all the disc brakes, wherein the suction device has a suction inlet connected via corresponding connecting lines to the suction connections of the casings.

As a preferred option, it is also possible here to arrange one or more air filters centrally in the commercial vehicle instead of fitting each disc brake with an air filter, as described with reference to FIG. 4. The air filter can be arranged, for example, at a readily accessible location in the commercial vehicle, thus enabling a change of filter to be carried out quickly without major effort.

All of the examples mentioned herein and also conditional phrases should be interpreted without limitation to such specifically presented exemplary embodiments. The disclosure is not restricted to the exemplary embodiments described here. There is room for various adaptations and modifications that a person skilled in the art would take into consideration on the basis of their expert knowledge as also belonging to the disclosure.

### List of Reference Signs (Part of the Description)

1 disc brake
4 brake caliper
6 brake disc pot
10 screws
12 casing
14 dust container
16 holes
18 suction device
20 compressed air connection
22 outlet
24 screws
26 air gap
30 suction device
32 compressed air connection
34 suction inlet
36 compressed air
38 annular gap
40 convex surface
42 air mass
50 suction device
52 compressed air connection
54 suction inlet
56 jet nozzle
58 outlet
70 disc brake
72 brake caliper
74 brake disc pot
76 casing
78 dust container
80 suction connection

What is claimed is:

1. A disc brake (1, 70) for a motor vehicle, comprising:
a brake disc and
a brake caliper (4), in which two brake pads and a mechanism for actuating the brake pads are arranged,
a casing (12, 76) that fits at least partially around the brake disc,
wherein the casing (12, 76) has a suction connection (80) for a particle extractor.

2. The disc brake (1, 70) as claimed in claim 1, wherein the brake disc includes a brake disc pot (6) and a friction ring, which is rigidly connected to the brake disc pot (6), and wherein the brake caliper (4) and the casing (12, 76) surround the friction ring, wherein an air gap (26) is disposed between the casing (12, 76) and the friction ring.

3. The disc brake as claimed in claim 2, wherein the air gap is open to ambient, wherein ambient air is drawn into the air gap and conveyed through the suction connection with dust generated by the disc brake in response to suction at the suction connection.

4. The disc brake (1) as claimed in claim 1, wherein an air-operated suction device (18, 30, 50) is secured on the suction connection of the casing (12).

5. The disc brake as claimed in claim 1, wherein the suction device includes a compressed air connection that receives compressed air, wherein the compressed air flows past a suction inlet of the suction device, wherein the suction inlet is attached to the suction connection of the casing, wherein air is drawn into the suction device from the suction connection through the suction inlet.

6. The disc brake as claimed in claim 5, wherein the suction device includes a convex surface air flows over a convex surface arranged at an annular gap around the suction inlet.

7. The disc brake as claimed in claim 5, wherein the suction device includes a jet nozzle disposed at the compressed air connection.

8. The disc brake (1) as claimed in claim 6, wherein the suction device (18, 30) is a vacuum generator, wherein the vacuum generator operates with a Coanda effect.

9. The disc brake (1) as claimed in claim 7, wherein the suction device (18, 50) is a vacuum generator, wherein the vacuum generator operates with a Venturi effect.

10. The disc brake (1, 70) as claimed in claim 1, wherein the casing (12, 76) includes a dust container (14, 78), wherein an air filter is arranged in the dust container.

11. The disc brake (1, 70) as claimed in claim 10, wherein the suction connection (80) for the particle extractor is arranged on the dust container (14, 78).

12. An extraction system for at least one disc brake (70) of a motor vehicle, comprising:
at least one disc brake as claimed in claim 1,
a suction device (30; 50), the suction device including:
a compressed air connection (32; 52) for connection to a compressed air system of the motor vehicle, and a suction inlet (34; 54) and
a connecting line for connection to the suction connection (80) of the casing (76) of the disc brake (70).

13. The extraction system as claimed in claim 12, wherein the motor vehicle includes multiple disc brakes (70), wherein multiple respective connecting lines extend to each of the disc brakes (70) of the motor vehicle for particle extraction from each of the disc brakes (70).

14. The extraction system of claim 13, wherein each of the disc brakes (70) have a casing (76) with a suction connection (80), and wherein each suction connection (80) of the casings (76) is connected to an air-operated suction device (30; 50) via the respective connecting line.

15. The extraction system as claimed in claim 14, wherein the air operated suction device (30; 50) operates with a Coanda effect or a Venturi effect.

16. The extraction system as claimed in claim 13, wherein the extraction system includes a particle extractor with a single air-operated suction device (30; 50) that provides suction to all of the disc brakes.

17. The extraction system as claimed in claim 13, wherein the extraction system includes one or more air filters arranged centrally in the motor vehicle and operable for all of the disc brakes.

18. The extraction system as claimed in claim 12, wherein the motor vehicle is a commercial vehicle with a compressed air system.

19. The extraction system as claimed in claim 18, wherein the compressed air system of vehicle provides compressed air to the suction device, wherein the compressed air from the compressed air system generates a vacuum in the suction device, and the suction device draws air out of each of the at least one disc brakes via respective connecting lines connected to the suction device.
